(19) United States
(12) Patent Application Publication
(10) Pub. No.: US 2016/0043559 A1
(43) Pub. Date: Feb. 11, 2016

(54) LOW-VOLTAGE MACHINE FOR PREPARING BEVERAGES, AND METHOD FOR OPERATING THE MACHINE

(71) Applicant: NOVADELTA - COMÉRCIO E INDÚSTRIA DE CAFÉS S.A., Lisboa (PT)

(72) Inventor: Rui Miguel NABEIRO, Campo Maior (PT)

(73) Assignee: NOVADELTA - COMÉRCIO E INDÚSTRIA DE CAFÉS S.A., Lisboa (PT)

(21) Appl. No.: 14/781,807

(22) PCT Filed: Apr. 1, 2014
(86) PCT No.: PCT/PT2014/000020

§ 371 Date: Oct. 1, 2015

(30) Foreign Application Priority Data
Apr. 2, 2013 (PT) 106862

(51) Int. Cl. H02J 4/00; A47J 31/44

(52) U.S. Cl. CPC H02J 4/00; A47J 31/4403

(57) ABSTRACT

The present invention discloses a machine (1) for preparing beverages such as for example coffee of the espresso type, that presents a plurality of electrical energy consumers (2), at least one internal energy source (3), means for connecting to at least one external energy source (4) and an energy management device (5) that supervises its operation at low voltage, both when it is operating connected to said external energy source (4) and when that is not the case.

The present invention further discloses a process for operation of a machine (1) for preparing beverages provided with means for operating at low voltage when supplied with electrical energy from said internal and/or from said external energy source (3, 4).

### FIELD OF THE INVENTION

The present invention refers to the field of the machines for preparation of aromatic beverages such as for example coffee of the espresso type and similar, and in particular to the operation of said machines autonomously in energy terms, i.e. without a connection to external energy sources such as for example an electrical energy distribution grid.

The present invention further refers to a process for operation of a machine for preparation of beverages with possibility of autonomous operation in energy terms.

### BACKGROUND OF THE INVENTION

Most of the machines for preparation of aromatic beverages, such as for example coffee of the espresso type and similar, operates based upon the supply of electrical energy by an external energy source, typically in the form of a fixed electricity distribution grid. The possibility of a machine of this type to operate autonomously from a fixed grid presents several advantages to certain types of portable use thereof.

In this sense, there are already known several solutions in prior art relating to said type of machines with operation autonomously from an external energy source, including portable machines (e.g., U.S. Pat. No. 6,123,010), and manual trolleys including said type of machines (e.g., CH 699674 A2). In all these cases, after the use of the energy available in respective energy storage devices, embodied for example as batteries or similar devices, it will be necessary to charge these before being able to use said machine again. Such an interruption of operation until the batteries are minimally charged up again represents a use constrain. The option of replacing the off-charged batteries with charged ones (e.g., WO 2012/046516 A1), adds to the cost of the machine, or to the effort of use thereof.

There are also known machines that present at least some energy consuming components operating at different voltages, eventually duplicated, according to whether the machine is in an operation mode using said storage devices, typically at low voltage direct current (DC), or connected to an external tension source, typically supplying a value of 220 V or 110 V in alternated current (AC). In this sense, the machines known in prior art are provided for operating at a given nominal tension, that is, they require changing components so as to operate at locations with different standard tensions of the power distribution grid. The document EP 1460353 A2 discloses a machine that operates always at 230 V AC presenting an inverter for increasing the tension to this level when operating based upon the battery. This solution presents lower energy efficiency and a bigger weight due to the integration of said inverter in the portable machine. The document WO 2006/102980 A1 presents two heating devices that are respectively actuated at a low voltage and at normal voltage from a power distribution grid. This type of solution represents a bigger number and complexity of the components in a machine.

Besides of the aforementioned aspects, it is very important that the machine can prepare a minimum number of beverages in acceptable pressure and temperature conditions when in autonomous operation mode. Given the high electrical power needs, in particular by the fluid compression and fluid heating devices, the machines that are known do not provide for the preparation of a minimum number of at least six coffees of the espresso type, preferentially at least twelve coffees of the espresso type, or equivalent energy service, successively in autonomous operation mode.

None of the aforementioned documents discloses a solution in view of a flexible operation of the machine with different types of supply tensions and without the duplication of components, and consequent increase in weight and costs, and in view of an optimized management of the energy resources in a beverage preparation machine according to the type considered herewith, so as to maximize the use of energy provided by the energy storage means.

### DESCRIPTION OF THE INVENTION

The goal of the present invention is to provide a machine for preparing beverages with possibility of operating with an internal energy source and, in case of unavailability of the latter, with possibility of preparing a beverage immediately after connection to an external energy source, including in the case the latter presents a higher voltage or not.

This goal is attained according to claim 1.

In particular, according to a first inventive aspect of the present invention, said goal is solved by means of a machine with energy distribution, use and control means provided so that they only use electricity at low voltage, and provided so that they can operate in operational connection to an internal energy source or to an external energy source, or, alternatively, with simultaneous connection to an internal energy source and to an external energy source.

According to a preferred embodiment, all the electrical energy consumers in said machine are provided so that they only use electricity at less than 50 V, preferentially between 24 V and 36 V, preferentially in direct current. The energy supply of said beverage preparation machine thus results advantageously provided by internal energy sources with high energy efficiency, including by means of direct energy supply from said internal energy sources to the electrical energy consumers, under better safety conditions and less total weight and costs, including as a result of avoiding a duplication of electrical energy consumers in said machine, and whereby the operating electrical tension of the main electrical energy consumers is appropriate to the preparation of a plurality of beverages of the espresso type, or similar.

According to another preferred embodiment, the machine according to the present invention presents an energy management device provided so that it can identify, including recognize and/or characterize, the availability of energy from said internal and/or external energy source, preferentially in each of successive moments at least during the beverage preparation period.

According to another preferred embodiment, said energy management device is provided so that it can determine when and/or which of the electrical energy consumers to be supplied by said internal energy source, or by said external energy source, or simultaneously by both types of said energy sources.

According to another preferred embodiment, said energy management device is provided so that it can determine a sequence of energy supply periods and intervals between these energy supply periods, and vary operation parameters of at least some of the electrical energy consumers, including fluid compression means and fluid heating means.

According to another preferred embodiment, said energy management device is provided so that it can limit to a maximum of 450 W, preferentially to a maximum of 350 W, the average value of power provided to said electrical energy consumers during each beverage preparation cycle.

According to another preferred embodiment, said electrical energy consumers include fluid compression means and fluid heating means and the operation parameters thereof are the same independently of the value of tension provided by said external energy source.

Another goal related to the first goal of the present invention is to provide a machine that requires no replacement of components at locations with different tensions of the electrical energy distribution grid. That is to say, a machine whose main components present similar configurations and nominal operation parameters, regardless of the nominal tension value provided by an external energy source, in particular of the type fixed power distribution grid.

This goal is solved according to the present invention by means of a machine that presents, at least temporarily, a voltage transformation device for connection to an external energy source, including in the case of transformation of an alternated current at a higher voltage (e.g., 230 V AC) to a direct current at low voltage (e.g., 36 V DC), whereby said voltage transformation device is the same regardless of the nominal tension provided by said external energy source being used. Alternatively, the machine can be connected to a low voltage external energy source, eventually by means of said voltage transformation device.

According to a preferred embodiment, the electrical energy supplied by means of connection to an external energy source of different nominal tension is ensured by means of a voltage transformation device, in particular provided by a voltage transformation device that is at least temporarily disposed in circuit between an external energy source and the low voltage components of the machine.

According to another preferred embodiment, when operationally connected, said voltage transformation device is provided externally to the chassis of the machine, preferentially in a respective chassis, and with means for connecting to the machine including by means of wires or wirelessly.

According to another preferred embodiment, said voltage transformation device is a large entry interval voltage device.

According to another preferred embodiment, said voltage transformation device presents a nominal power of at most 600 W, preferentially at most 450 W.

According to another preferred embodiment, said internal energy source is provided in the form of energy storage means with a nominal capacity of energy storage and discharge sufficient to prepare at least six, preferentially at least twelve, more preferentially at least eighteen beverages, of 20 to 50 ml, with temperature requirements of between 80° C. and 100° C. and pressure of at least 8 bar, or the number of beverages with an equivalent energy service.

According to another preferred embodiment, said energy storage means are provided with a maximum nominal storage capacity of 120 Wh, preferentially of 80 Wh and a discharge capacity of at least 5 C, preferentially at least 10 C.

According to another preferred embodiment, said external energy source includes a power distribution grid with a voltage above 50 V, and an energy generation and/or storage device with any voltage and provided so that it can be operationally connected to the machine.

Another goal of the present invention is to provide a process that enables an optimized used of the available energy resources, in particular in view of a substantially uninterrupted availability of the machine to prepare a beverage and of a minimization of the charging period of the internal energy sources.

This goal is attained by means of a process according to which, once the machine is turned on, an energy management device identifies, including by means of recognizing and/or characterizing, the availability of energy by said at least one internal energy source and said at least one external energy source, and the energy demands by the energy consuming components provided in the machine, and determines the supply of electrical energy to the energy consumers and/or to said at least one internal energy source, whereby in case said internal energy source is unavailable, then said energy management device determines the energy supply to said energy consumers, preferentially exclusively to said energy consumers, by means of said at least one external energy source.

It thus results that the energy supply to said energy consumers is provided by said, at least one, external energy source, preferentially exclusively to these energy consumers, so as to provide the possibility of preparing a beverage shortly after, preferentially right after establishing a functional connection between the machine and said, at least one, external energy source, and so as to minimize the period of time required to charge the internal energy source without compromising the availability of the machine to prepare beverages during said period of time.

Moreover, according to the process according to the present invention, said energy management device determines the energy supply by said external energy source, at least until reaching a given charging level of said at least one internal energy source. Preferentially, the energy supply by the external energy source is maintained while the machine is connected to said external energy source.

According to a preferred embodiment, the process further includes a step in which said energy management device determines the energy supply to said at least one internal energy source in the periods of time during which a beverage is not being solicited or prepared, so as to minimize the period of time required by the charging of said internal energy source, without compromising the availability of the machine to prepare beverages during that period of time.

According to another preferred embodiment, said energy management device determines the energy supply simultaneously to said energy consumers and to said, at least one, internal energy source.

According to another preferred embodiment, said energy management device determines that the energy supply to said energy consumers is provided by the external energy source while the latter is available, even after reaching the maximum energy level in said, at least one, internal energy source.

According to another preferred embodiment, the energy supply to said at least one internal energy source is carried out by means of regulation of a pulse-width modulation signal, so as to supply a substantially constant charging current until reaching a given value of tension, whereby said value of tension is maintained until said charging current is inferior to a given, preferentially a previously defined, reference value of tension.

In the scope of the present description, by “internal energy source” there should be understood a device and/or respective operational connection means, with or without final energy generation capacity from any primary energy source, including energy storage and conversion devices, such as for example batteries and similar, and that provide the energy supply, in particular of electrical energy, without the machine for preparing beverages being connected to a fixed power distribution grid.

In the scope of the present invention, it is considered that internal energy sources correspond to temporary storage or accumulation of any energy form enabling a later supply of electrical energy, in particular those devices operating based upon an electrochemical and/or electromagnetic energy conversion process, such as for example batteries and similar, in particular at low voltage. Moreover, it is considered that the internal energy sources correspond to energy devices provided inside or outside of the machine for preparing beverages, with or without the possibility of access and/or replacement from the outside, preferentially configured for exclusive use with the machine for preparing beverages.

The machine for preparing beverages carries out a process including heating of at least one processing fluid, for example water, up to a temperature of 80° C.-100° C. and/or the compression of at least one processing fluid up to a pressure of at least 8 bar.

The machine for preparing beverages according to the present invention is used for preparing coffee, milk, tea and similar, and uses water, milk, tea and similar as processing fluid.

### LIST OF FIGURES

The invention shall now be explained in greater detail based upon preferred embodiments and the attached Figures.

The Figures show:

FIG. 1: schematic representations in cut side view, front view and top view, of a first embodiment of a machine (1) according to the invention;

FIG. 2: schematic representations in cut side view, front view and top view, of a second embodiment of a machine (1) according to the invention.

### DESCRIPTION OF EMBODIMENTS OF THE INVENTION

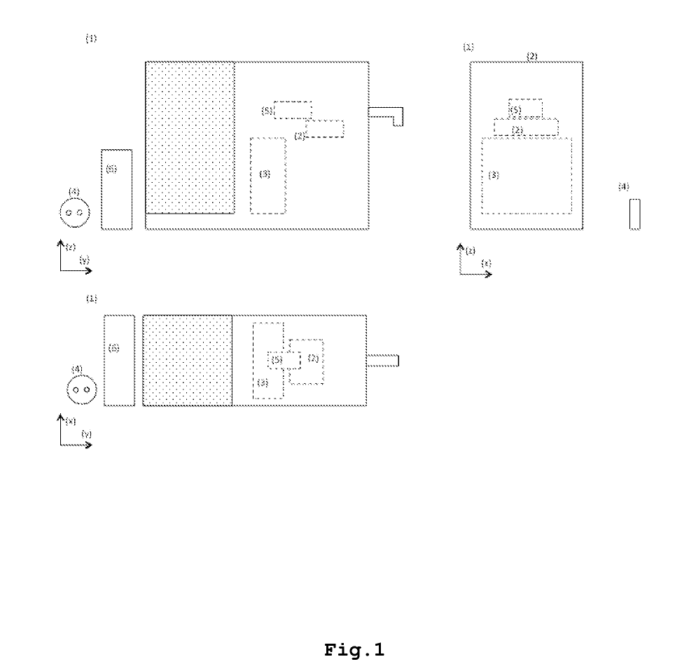

FIG. 1 presents schematic representations, in side view in the top left corner, front view in the top right corner, and in top view in the bottom left corner, of a machine (1) for preparing beverages by means of extraction of an edible aromatic substance, such as for example coffee, tea and similar. The machine (1) presents a fluid reservoir (shaded represented) and a plurality of energy consumers (2), including heating and compression means of a processing fluid, including water, represented jointly and in simplified manner.

According to a first inventive aspect of the invention, the machine (1) is provided with an electrical circuit and an energy management device (5) that ensure its operation only at low voltage, preferentially between 24 and 36 V, preferentially in direct current (DC), both when operating in autonomous mode and when connected to an external energy source, such as for example a fixed power distribution grid. The operation based upon a connection to an external energy source (4) is provided by means of a voltage transformation device (6).

Moreover, the machine (1) can operate in autonomous mode based upon at least one internal energy source (3) provided internally or externally to the machine chassis and in removable manner or not. In particular, said energy management device (5) identifies, including by means of recognition and characterization, the energy availability in at least one internal energy source (3), provided for example in the form of an electrochemical battery or similar, and manages the operation of charge and discharge thereof as a function of the availability of an external energy source (4) and of the requests of beverage preparation.

In this sense, if the energy level in said internal energy source (3) is below a previously defined minimum level, then the machine (1) is ready to prepare a beverage right after being connected to an external energy source (4), because the energy management device (5) determines that the latter supplies directly the energy consumers (2), and simultaneously or in the intervals between beverage preparation request, supplies said internal energy source (3). It is thus advantageously provided that the machine (1) according to the invention provides a high level of readiness to prepare a beverage, even in the period immediately after being connected to an external energy source (4) and presenting an internal energy source (3) presenting a reduced energy level.

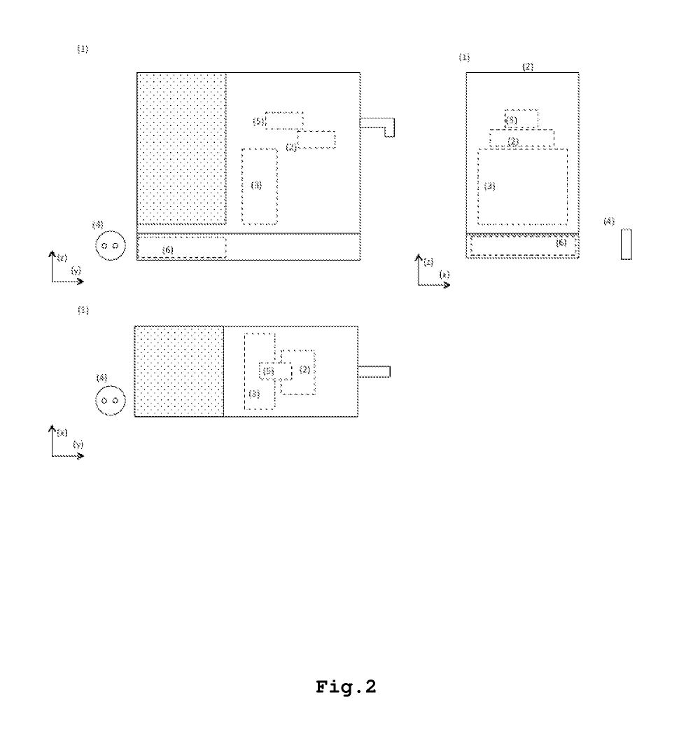

FIG. 2 shows a second embodiment of the machine (1) according to the invention, in similar manner and in views corresponding to those of FIG. 1.

As aforementioned, according to another inventive aspect, the energy management device (5) and the energy consumers (2), as well as the electrical circuit, are provided so that the machine (1) always operates at low voltage direct current, below 50 V DC, preferentially between 24 V and 36 V DC. This solution presents several advantages including better safety of use and non-duplication of components, in particular of the fluid heating means. Moreover, this solution makes it possible to use always the same components, regardless of the nominal tension value of the energy distribution grid in a given country.

In this sense, the machine (1) for preparation of beverages is further provided with a voltage transformation device (6), preferentially provided as wide entry interval device for supplying direct current (DC), disposed between an external energy source (4) with voltage bigger than low voltage, and the other components of the machine (1). In particular, said voltage transformation device (6) can be provided outside of the main chassis of the machine (1), or inside thereof.

According to a preferred embodiment, the voltage transformation device (6) is provided in an element that engages in adjusted manner with a part of the chassis of the machine (1), as represented in FIG. 2.

Lisbon, 28^{th} of Apr. 2014.

1. A machine (1) for preparation of beverages from at least one aromatic substance, including coffee of espresso type and similar, presenting:
a plurality of electrical energy consumers (2),
at least one internal energy source (3),
connection means adapted for functional connection of the machine (1) to at least one external energy source (4), and
an energy management device (5) provided so that it can supervise and regulate the supply and distribution of electricity to at least some of said electrical energy consumers (2),
characterized
in that said electrical energy consumers (2) are provided so that they can only use electrical energy at low voltage, including from said at least one internal energy source (3) or from said at least one external energy source (4) or from both these types of energy source (3,4) simultaneously, whereby said energy management device (5) is further provided so that it can identify the availability of energy in said internal energy source (3) and/or in said external energy source (4) and determine which energy source (3, 4) to use at least as a function of the availability of energy in said internal (3) and/or in said external (4) energy source.

2. The machine (1) according to claim 1, characterized in that said electrical energy consumers (2) are provided so that they can only use electrical energy at a value of voltage inferior to 50 V, preferentially between 24 V and 36 V, preferentially of direct current (DC), whereby the machine (1) further presents a voltage transformation device (6) for connection to an external energy source (4) presenting a greater value of nominal voltage.

3. The machine (1) according to claims 1, characterized in that said energy management device (5) is provided so that it can determine when and/or which electrical energy consumers (2) to be supplied by said internal energy source, or by said external energy source (4), or simultaneously by both types of energy source (3, 4).

4. The machine (1) according to claim 1, characterized in that said energy management device (5) is provided so that it can determine a sequence of energy supply periods and intervals between these supply periods, as well as to vary operation parameters of at least some of said electrical energy consumers (2) de, including fluid compression means and fluid heating means.

5. The machine (1) according to claim 1, 4, characterized in that said energy management device (5) is provided so that it can limit the average value of power provided to said electrical energy consumers (2) to a maximum of 450 W, preferentially to a maximum of 350 W, during each beverage preparation cycle.

6. The machine (1) according to claim 1, characterized in that said electrical energy consumers (2) include fluid compression means and fluid heating means and in that the operation parameters thereof are the same independently of the value of voltage provided by said external energy source (4).

7. The machine (1) according to claim 1, characterized in that said voltage transformation device (6) is provided externally to the machine chassis (1), preferentially in a respective chassis, and with means for connecting to the machine (1), including by means of wires or wirelessly.

8. The machine (1) according to claim 2, characterized in that said voltage transformation device (6) is a large entry interval voltage device.

9. The machine (1) according to claim 2, characterized in that said voltage transformation device (6) presents a nominal power of at most 600 W, preferentially at most 450 W.

10. A process for operation of a beverage preparation machine, in particular of a machine (1) for preparing beverages according to claim 1, comprising the following steps:
turning the machine (1) on;
identifying, by means of an energy management device (5) provided in the machine (1), the availability of at least one internal energy source and/or of at least one external energy source (4) for supplying electrical energy to electrical energy consumers (2) provided in said machine (1),
determining, by means of said energy management device (5), the supply of electrical energy to said electrical energy consumers (2) and/or to said at least one internal energy source (3),
whereby, in case of unavailability of the internal energy source (3), said energy management device (5) determines the supply of electrical energy to said electrical energy consumers (2) by said at least one external energy source (4), preferentially exclusively to said electrical energy consumers (2).

11. The process according to claim 10, characterized in that said energy management device (5) determines the supply of electrical energy to said at least one internal energy source (3) during the periods of time in which no beverage is being solicited or prepared.

12. The process according to claim 10, characterized in that said energy management device (5) determines the supply of electrical energy simultaneously to said electrical energy consumers (2) and to said at least one internal energy source (3).

13. The process according to claim 10, characterized in that said energy management device (5) determines the supply of electrical energy to said electrical energy consumers (2) by said external energy source (4) as long as the latter is available, even after reaching a maximum energy level at said at least one internal energy source (3).

14. The process according to claim 10, characterized in that the supply of electrical energy to said at least one internal energy source (3) is carried out by means of a pulse-width modulation signal, so as to supply a substantially constant charging electrical current until reaching a previously defined value of tension, whereby this value of tension is maintained until the charging electrical current is inferior to a given reference value of tension, preferentially to a previously defined reference value of tension.

15. Process The process according to claim 10, characterized in that said energy management device (5) provides for the display of an indicator of energy availability, preferentially discriminated by said internal energy source (3) and said external energy source (4), by means of at least one use interface of said machine (1).
